(19) United States
(12) Patent Application Publication
(10) Pub. No.: US 2008/0016357 A1
(43) Pub. Date: Jan. 17, 2008

(54) Method of securing a digital signature

(75) Inventor: Luis Antonio Suarez, Concord, NC (US)

Correspondence Address: KENNEDY COVINGTON LOBDELL & HICKMAN, LLP, 214 N. TRYON STREET, HEARST TOWER, 47TH FLOOR, CHARLOTTE, NC, 28202, US

(73) Assignee: WACHOVIA CORPORATION, Charlotte, NC (US)

(21) Appl. No.: 11/487,272

(22) Filed: Jul. 14, 2006

(51) Int. Cl. H04L 9/00

(52) U.S. Cl. 713/176

(57) ABSTRACT

A method of securing a digital signature in a networked computer system. A user having a user private key and a user public key obtains a digital certificate from a certificate authority. The user takes an overt action showing the intent to sign an artifact initiating a signing ceremony. The user signs the artifact using the user private key. The digital certificate is attached to the artifact after signing by the user. The user private key is programmatically destroyed upon completion of the signing ceremony.

### FIELD OF THE INVENTION

The present invention relates generally digital signatures, more particularly to a method of securing a digital signature by use of a short-lived private key.

### BACKGROUND OF THE INVENTION

A digital signature is an electronic signature that can be used to authenticate the identity of the sender of a message or the signer of a document. It also may be used to ensure that the original content of a message or a document that has been sent remains unchanged. A digital signature typically employs Public Key Infrastructure (PKI) as the technology to apply a signature and to seal the document as proof of document integrity.

A problem with digital signatures in the e-commerce world today is one of lifecycle management for the credentials used to sign the electronic documents. For example, one type of credential is a digital certificate. A digital certificate is an electronic means of establishing a party's credentials when doing business or other transactions on the internet. It is issued by a Certificate Authority (CA) and typically contains identifying information about the certificate holder, a copy of the certificate holder's public key (used for encrypting messages and validating digital signatures), and the digital signature of the certificate-issuing authority so that a recipient can verify that the certificate is authentic.

As indicated above, the use of a digital certificate to apply the digital signature is encumbered by the necessity to secure the credential for the life of said credential. Digital certificates, by industry standards, have expiration dates and typically a life of one year. An end entity (person) with a digital certificate and the associated private key must protect the private key for the term of the life of the certificate. This creates many issues when one considers the possible population of users that could digitally sign documents and that have no knowledge of the technology and the legal liability associated with protecting the private key from compromise. Compromise of the private key can lead to repudiation of any signature performed with the credential. It would be desirable to retain the digital certificate for an extended period of time without concern about compromise of the integrity of the public and private key pair. Thus, in an attempt to solve the above problem, the present invention relates to a “short-lived” private key for use with a digital signature and to the method of securing the digital signature.

### SUMMARY OF THE INVENTION

The present invention provides for a method of securing a digital signature in a networked computer system. The method comprises obtaining from a certificate authority a digital certificate by a user having a user private key and a user public key, taking an overt action showing the intent to sign an artifact by the user to initiate a signing ceremony, signing the artifact by the user using the user private key during the signing ceremony, attaching the digital certificate to the artifact after signing by the user, and programmatically destroying the user private key upon completion of the signing ceremony.

In accordance with another aspect of the method of the present invention, the artifact is hashed using a hashing algorithm to generate a hash and the hash is encrypted with the user private key.

The present invention also provides for a method of securing a digital signature in a networked computer system in which a user and a user machine are identified by a webserver, the user machine is instructed to create an asymmetric key pair having a user private key and a user public key for storage on the user machine, the public key and any identifying user information are retrieved from the user machine by the webserver to send to a certificate authority to issue a digital certificate to the user, the digital certificate is installed by the webserver on the user machine, an artifact is presented to the user for the user to sign with the user private key, and the user machine is instructed to destroy the user private key at the user machine after the artifact is signed by the user.

The present invention also provides for a method of securing a digital signature in a networked computer system in which a user and a user machine are identified by a webserver, the user machine is instructed to create an asymmetric key pair having a user private key and a user public key for storage on the webserver on behalf of the user, the public key and any identifying user information are retrieved from the user machine by the webserver to send to a certificate authority to issue a digital certificate to the user, an artifact is presented to the user from the webserver for the user to sign with the user private key, and the webserver is instructed to destroy the user private key after the artifact is signed by the user.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram illustrating the environment in which the method of the present invention operates.

FIG. 2 is a flowchart illustrating a method of obtaining a digital certificate by a user for use in signing.

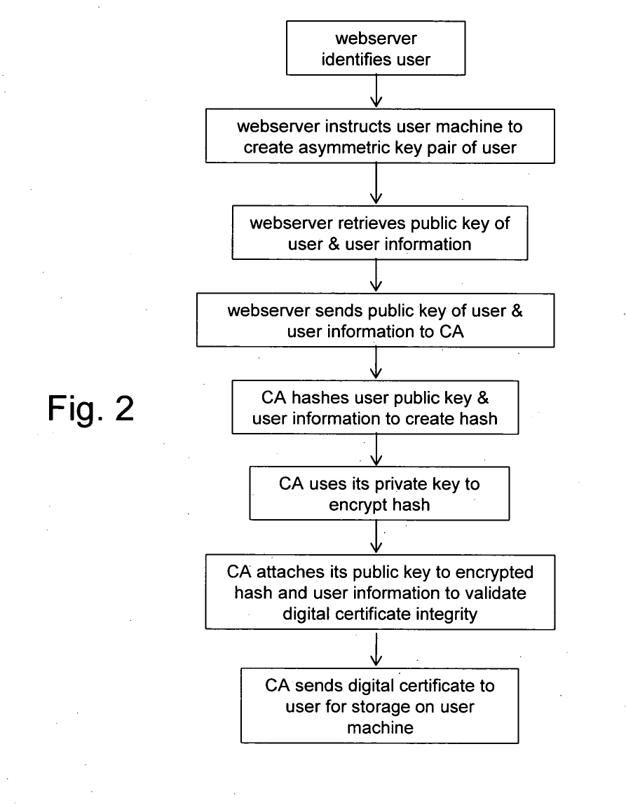

FIG. 3 is a flowchart illustrating the method of securing a digital signature in accordance with the present invention.

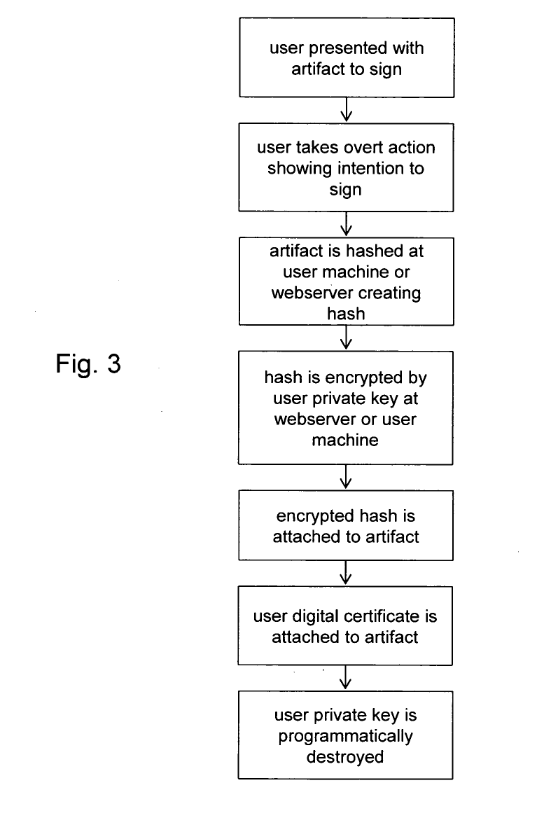

### DESCRIPTION OF THE PREFERRED EMBODIMENTS

The method of the present invention relates to digital signatures, more particularly to a method of securing a digital signature by use of a short-lived private key.

Referring now to the drawings, in which like numerals represent like components throughout the several views, the preferred embodiments of the present invention are next described. The following description of the preferred embodiment(s) is merely exemplary in nature and is in no way intended to limit the invention, its application, or uses.

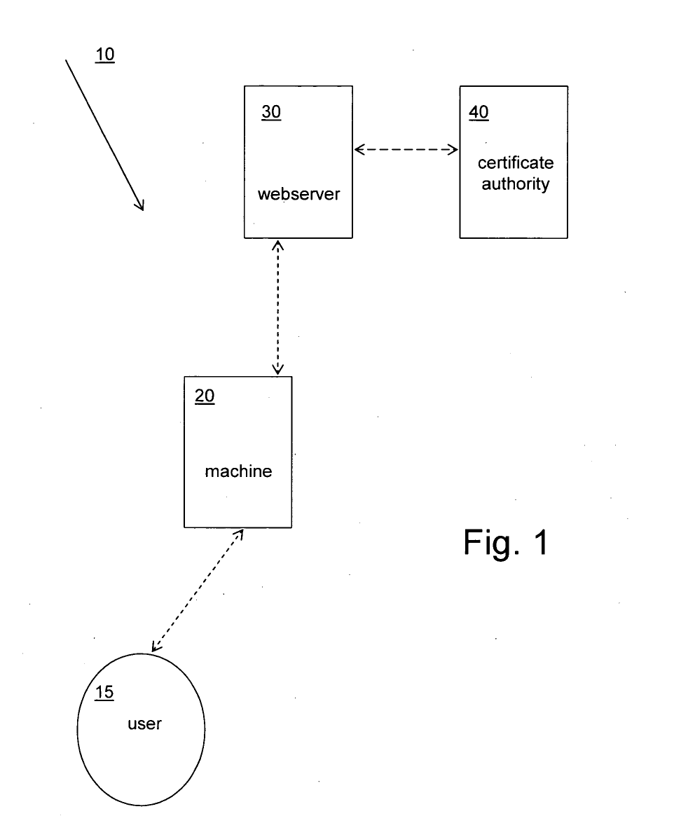

FIG. 1 is a block diagram illustrating the environment 10 in which the method of the present invention operates. The following discussion assumes a web-based or e-mail based environment, but the present invention is not limited to such an environment. In accordance with the method of the present invention, a user 15 accesses a machine 20. The term “machine”, as used herein, refers to a computer or other device having the capability of storing a symmetric key or an asymmetric key such as, for example, a USB token or a smartcard or any other device or means of containing a digital certificate and an asymmetric key. Using the machine 20, the user 15 connects to a webserver 30. The user 15 then presents itself to a website on the webserver 30. The webserver 30 then verifies the identity of the user 15 that will ultimately be performing the signing of an artifact. The webserver 30 may use an approved agent to act as a registration authority (RA) (not shown). The term “artifact,” as used herein, refers to information that will be digitally signed. An artifact includes, but is not limited to, a document, data, image, music, file, and other information. Verification typically consists of the business and regulatory requirements necessary for proper identification of the user 15. For example, the user 15 may have to complete a subscriber agreement. The user 15 may also need to enter identifying user information such as first name, last name, userid, location, and email address. This identifying information plus date and time are typically part of the “common name” in the digital certificate to be issued. Once the user 15 has been authorized access, an asymmetric key pair (a public key and a private key) is generated on the machine 20 of the user. The user information is sent via secure session (Web server SSL) to a certificate authority (CA) 40. A certificate authority issues and manages security credentials and public keys for message encryption. As part of PKI, the CA may check with the RA to verify the information provided by the user 15.

The CA 40 then hashes the user information and the public key of the user 15 with a one-way hash algorithm. Hashing is the transformation of a string of characters into a numeric or other value that represents the original string. The hashing algorithm is called a hash function.

The CA 40 uses its private key to encrypt the “hash.” The encrypted hash may be in any number of file formats including, but not limited to, ASCII, base 64 encoding, PEM encoding or others. The CA 40 attaches the encrypted hash to the user information and user public key and also attaches the public key of the CA 40 forming the digital certificate. The digital certificate is sent from the CA 40 to the user 15 via a web session, email, floppy disk, or other means and resides on the machine 20 of the user 15.

A digital certificate can be tied to biometric data or information. Examples of biometric data include, but are not limited to, finger print, voice, handwriting, and facial recognition. Biometric information can be captured in the case that an electronic signature pad or other biometric device is used as a portion of the signing ceremony. The biometrics with the digital signature could be used together to provide forensics if a signature is repudiated. Biometric information is typically added into the artifact before the hash is completed. This type of information may be helpful for the purposes of legal non-repudiation to tie the user to the act of signing.

In accordance with the method of the present invention, when a user 15 wants to sign an artifact or when a user is presented with an artifact for signing by the webserver 30, for example, the user 15 uses it private key to digitally sign the artifact. The user 15 takes an overt action showing the intention to sign. For example, the user could perform the signing action by any number of methods including, but not limited to, signing with a pen on a tablet, clicking with a computer mouse on the sign-here field, selecting the sign-here box, and pressing a key that would instruct the computer to perform the signing. The artifact is hashed using a hashing algorithm. An example of a hashing algorithm includes, but is not limited to, SHA, SHA1, and MD5. Hashing may occur on the user machine or the webserver. The hash is then encrypted by the private key of the user. The act of signing comprises hashing the artifact using the hashing algorithm and encrypting the hash with the user private key. The encrypted hash becomes the digital signature of the user 15 and is attached to the artifact to be verified later. The digital certificate of the user 15 is attached to the artifact. Thus, once the signing ceremony is complete, the private key is programmatically destroyed. The term “programmatically” as used herein refers to programmed instructions to destroy the user private key after the signing ceremony is complete. For example, these instructions may be programmed in the code of the user machine or may be sent to the user machine by the webserver. Hence, since the user private key is programmatically destroyed, it is “short-lived.” Once destroyed, the private key is unable to sign any more artifacts.

Upon completion of the signing ceremony and once the private key has been programmatically destroyed, the event could be logged and audited in a “secure log.” A “secure log” would comprise an audit of all events where any tampering would be evident. The log could be signed and/or encrypted. Also, a copy of the signed artifact could be printed as proof of the transaction.

It is preferred but not required that the private key is both created and destroyed at the machine 20 of the user 15. The private key of the user 15 may get to the webserver 30 where document is “presented” from the computer screen of the user 15 but could not be compromised at that server because only the user could use the private key at that server. The artifact may get signed at the user machine 20. Thus, the webserver 30 may get access to the private key of the user 15.

Only the public key corresponding to the associated private key can be used to decrypt the hash and to check, for example, for data integrity and for technical non-repudiation. Technical non-repudiation refers to the ability to prove that the private key of the user signed the artifact. This is in contrast with legal non-repudiation in which one has to prove that it was really the user who actually signed the artifact with the private key of the user.

There are numerous methods that may be employed to programmatically destroy the private key of the user in accordance with the method of the present invention. The public and private keys, for example, may be created in memory in the web browser of the user machine. Thus, the memory can be cleared in the browser (temporary memory). The user may hit the “finish” or “end” button, for example, and trigger automatic destruction of the private key.

Another method for programmatically destroying the private key may involve placing the private key in an operating system (such as a Windows registry) in the computer or other electronic device of the user. During signing, computer code is accepted and the code issues instructions to destroy the private key. The code knows whether the private key is resident on the browser or whether resident on the user computer. Examples of code include, but are not limited to, Java, C, C++, and NET. The private key is typically more permanent in workstation with registry because to delete the private key an entry needs to be made in the operating system.

Another alternative method of programmatically destroying the private key in the case of a USB token, smart card or other electronic device, for example, is that the manufacturer for the respective device may provide an application program interface (API) that facilitates destruction of the private key. Examples of available programs include, but are not limited to, Token Management System (TMS) from Alladin Inc., Gemsafe from Gemplus Inc., and Affina by the Datacard Group.

Thus, there are numerous advantages associated with the method of the present invention. The present invention would eliminate the need for life cycle management of the digital certificate. The private key that needs to be secured would be programmatically destroyed and the digital certificate that was valid at the time of the signing ceremony would be captured with the artifact for verification at any time in the future. As a further safeguard, the digital certificate could be revoked and listed on a Certificate Revocation List (CRL) or Online Certificate Status Protocol (OSCP) server or any other form of certificate revocation. However, with the method of the present invention, the digital certificate itself would not need to be short-lived because the private key would be short-lived and not be able to sign any more artifacts after destruction. Therefore, the expiration date may be of any duration but at a minimum the length of the signing ceremony.

The following is a prophetic example in accordance with the present invention illustrating a method to programmatically destroy a private key from a key container using Microsoft.NET software for Windows and its respective terminology. It is merely exemplary in nature and is in no way intended to limit the invention, its application, or uses.

In step 1, a new instance of a CspParameters (Cryptographic service provider) class is created and the name for the key container is passed to the CspParameters.KeyContainerName field. In step 2, using an asymmetric algorithm to construct the key container to hold the asymmetric key, the name and parameters are passed to the key container (i.e. a new instance of a class that derives from the AsymmetricAlgorithm class usually RSACryptoServiceProvider or DSACryptoServiceProvider is created and the previously created CspParameters object are passed to its constructor. In step 3, set from persistent to non-persistent by setting to false. Persistent means remains or persists even if rebooted (need to take out of protected memory to volatile memory). The PersistKeyInCSP property of the class that derives from AsymmetricAlgorithm is set to false (False in Visual Basic). In step 4, the private key is deleted by calling the clear command (i.e. make it non-persistent to call the clear). Call the Clear method of the class that derives from AsymmetricAlgorithm. This method releases all resources of the class and clears the key container.

In non-programming terminology, the developer creates an asymmetric key in memory on the client or server computer, making sure that it does not live beyond a reboot (is non-persistent). After the key is used, it is cleared or erased.

Other methods can be coded for programmatically destroying the private key. Examples include, but are not limited to, Active X and Windows DLL. The key pair and associated digital certificate may have any arbitrary valid from, valid to dates (i.e. life). The life of the digital certificate should be long enough to provide for the completion of the signing ceremony of the artifact but not so long that if the destruction of the private key were not performed, there would be an unreasonable amount of time for compromise.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed is:

1. A method of securing a digital signature in a networked computer system, the method comprising:
obtaining from a certificate authority a digital certificate by a user having a user private key and a user public key,
taking an overt action showing the intent to sign an artifact by the user to initiate a signing ceremony,
signing the artifact by the user using the user private key during the signing ceremony,
attaching the digital certificate to the artifact after signing by the user, and
programmatically destroying the user private key upon completion of the signing ceremony.

2. The method according to claim 1, wherein signing further comprises hashing the artifact.

3. The method according to claim 2, wherein signing further comprises encrypting the hashed artifact.

4. The method according to claim 1, wherein the user private key has a life of a shorter duration than the life of the digital certificate.

5. The method according to claim 1, wherein the artifact is a document, data, an image, music, a file, or other information.

6. A method of securing a digital signature in a networked computer system, the method comprising:
obtaining from a certificate authority a digital certificate by a user having a user private key and a user public key,
hashing an artifact using a hashing algorithm to generate a hash,
encrypting the hash with the user private key,
attaching the encrypted hash to the signed artifact,
attaching the digital certificate to the signed artifact, and
programmatically destroying the user private key after attachment of the encrypted hash and digital certificate to the artifact.

7. The method according to claim 6, wherein the artifact is a document, data, an image, music, a file, or other information.

8. The method according to claim 6, wherein the networked computer system is comprised of a user machine, webserver, and certificate authority.

9. The method according to claim 8, wherein the user machine is a computer or electronic device.

10. The method according to claim 6, wherein the user private key has a life of a shorter duration than the life of the digital certificate.

11. A method of securing a digital signature in a networked computer system, the method comprising:
identifying a user and a user machine by a webserver,
instructing the user machine to create an asymmetric key pair having a user private key and a user public key for storage on the user machine,
retrieving the public key and any identifying user information from the user machine by the webserver to send to a certificate authority to issue a digital certificate to the user,
installing the digital certificate by the webserver on the user machine,
presenting an artifact to the user for the user to sign with the user private key, and
instructing the user machine to destroy the user private key at the user machine after the artifact is signed by the user.

12. The method according to claim 11, wherein the artifact is a document, data, an image, music, a file, or other information.

13. The method according to claim 11, wherein the method further comprises attaching the user public key to the signed artifact.

14. The method according to claim 11, wherein the networked computer system is comprised of a user machine, webserver, and certificate authority.

15. The method according to claim 14, wherein the user machine is a computer or electronic device.

16. The method according to claim 11, wherein the user private key has a life of a shorter duration than the life of the digital certificate.

17. A method of securing a digital signature in a networked computer system, the method comprising:
identifying a user and a user machine by a webserver,
instructing the user machine to create an asymmetric key pair having a user private key and a user public key for storage on the webserver on behalf of the user,
retrieving the public key and any identifying user information from the user machine by the webserver to send to a certificate authority to issue a digital certificate to the user,
presenting an artifact to the user from the webserver for the user to sign with the user private key, and
instructing the webserver to destroy the user private key after the artifact is signed by the user.

18. The method according to claim 17, wherein the artifact is a document, data, an image, music, a file, or other information.

19. The method according to claim 17, wherein the networked computer system is comprised of a user machine, webserver, and certificate authority.

20. The method according to claim 19, The method according to claim 1, wherein the user private key has a life of a shorter duration than the life of the digital certificate.
